(19) United States
(12) Patent Application Publication
(10) Pub. No.: US 2004/0170806 A1
(43) Pub. Date: Sep. 2, 2004

(54) Tile structures having phase change material (PCM) component for use in flooring and ceilings

(75) Inventors: Douglas C. Hittle, Fort Collins, CO (US); Amy Sarah Lee, Loveland, CO (US)

Correspondence Address: JEAN M. MACHELEDT, 501 SKYSAIL LANE, SUITE B100, FORT COLLINS, CO, 80525-3133, US

(73) Assignee: University of Colorado Research Foundation

(21) Appl. No.: 10/791,507

(22) Filed: Mar. 1, 2004

Related U.S. Application Data
(60) Provisional application No. 60/450,838, filed on Feb. 28, 2003.

(51) Int. Cl. B32B 1/00

(52) U.S. Cl. 428/141

(57) ABSTRACT

Agglomerate tile structures and ceiling tile structures: The agglomerate tile structures can be of a single layer having an intermixed granular base medium comprised of one or more subcomponent materials (e.g., powdered, crushed, chips, and/or other broken pieces of varying sized particles, of quartz, granite, limestone, marble, glass, ceramic, semiprecious stones, etc.), plus a binder material and a PCM component; or the agglomerate tile structures can be of multiple layers, such as having an outer wear-layer substantially absent of PCM component-this outer wear-layer being bonded or otherwise incorporated with a second layer comprised of a binder material and a PCM component, substantially absent of the granular base medium. While applicants contemplate that the tile structures can be of a myriad of shapes and sizes, and associated features of the apparatus will be accordingly sized and fabricated of material(s) suitably compatible, traditionally-shaped generally planar tiles as well as tiles having curvilinear surfaces, may be fabricated according to the invention.

The invention disclosed herein was made with United States government support awarded by the Department of Energy, award N^{o.}DE-FC26-00NT40999. Accordingly, the U.S. Government has certain rights in this invention. This application claims the benefit of pending U.S. provisional patent application No. 60/450,838 filed 28 Feb. 2003 by and on behalf of both applicants hereof.

### BACKGROUND OF THE INVENTION

In general, the present invention relates to tile structures for use in thermal management systems that are comprised of a component phase change material (PCM) having dynamic thermal-, moisture-, and/or energy-storage properties, such as microspheres filled with phase change material, microcapsules containing phase change material, as phase change material incorporated into the structure of the fibers, as hollow fibers or pores filled with phase change material, phase change material impregnated upon non-hollow fibers, as a laminate or coating with a phase change layer, etc.). The use of ‘smart’ construction materials to better thermally regulate an environment (be it the climate of living or office space(s), research laboratories, production facilities, and so on) can play an important role in reducing energy consumption in connection with passive solar systems. Of particular interest are tile structures adaptable for use as flooring, in ceilings, decorative wall-coverings, bath/shower/sink moisture-barriers, countertops, jungle-gym structures (e.g., those found outdoors in parks that are exposed to daily temperature fluctuations), interior and exterior manufactured members used in construction (e.g, beams, planks, framing supports, sheetrock/drywall, exterior siding, patios, decorative molding/edging, roof shingles, etc.) and so on.

Incorporating passive solar systems into residential, business, sunroom, etc. buildings significantly reduces heating and cooling energy consumption. The integration of phase change materials into building materials, especially Trombe walls, ceilings, and floors, according to the invention for use in passive heating and cooling systems enhances thermal storage of the building materials.

The latent heat storage capacity of a phase change material (PCM), such as encapsulated paraffin wax or an encapsulated salt hydrate, make PCM's ideal for passive solar applications. Latent heat is released when the material changes from a liquid to a solid. PCMs that undergo a phase transition from one solid form to another solid form, and release heat, are known as solid-state PCMs. While encapsulated paraffin wax is a preferable PCM for use according to the invention—due to its high latent heat, non-reactive behavior with polyester resin and minimal under-cooling effects—others may be employed according to the invention.

Ice is one technical modality currently used in commercial building applications to store “coolth” at night by running refrigeration equipment. During the day, the refrigeration equipment is turned off to reduce peak electrical demand. To store heat (from the sun, for example), however, a different phase change material is needed. In the past, others have attempted to place paraffin, alone, and solid-state phase change materials (PCM) into building products such as wallboard and concrete (D. K. Benson U.S. Pat. No. 4,572,864). Among the hurdles those earlier attempts faced, was how to place sufficient PCM in the building product or system to produce significant energy savings without unduly degrading the physical properties of the material. For example, researchers at Oak Ridge National Laboratory and in Japan tried to impregnate dry wall with paraffin wax. Problems encountered included oozing, lack of structural integrity (crumbling), odor, out gassing and fire retarding and finishing issues. Researchers at the National Renewable Energy Laboratory explored using the solid-state phase change material, a neopentyl glycol blend, in concrete. They proposed to dissolve the PCM in the water used to make the concrete. It was found that such little amount of PCM could be incorporated in the final concrete slab that it would not provide significant energy savings. A US government-NASA sponsored research effort led to the development of microencapsulated phase change material for use in satellites, please see Benson, D. K., Webb, J. D., Burrows, R. W., McFadden, J. D., Christensen, C. “Materials Research for Passive Solar Systems: Solid-State Phase-Change Materials” (1982). The paraffin material that was encapsulated had a solid-to-liquid transition temperature of about 28° C. or 82° F. Very recently, a microencapsulated PCM has been used in fabrics for garments worn to reduce skin temperature fluctuations. Companies such as Columbia, Eddie Bauer, and Wigwam sell garments containing phase change fabrics.

At present, a commonly used technology for storing solar energy in a solarium or sunroom is a simple concrete slab floor. The agglomerate floor tile structures of the invention have a number of advantages over concrete flooring: Lighter weight, stores more energy, may be laid over an ordinary sub-floor. The ceiling tile structures of the invention having a PCM component may reduce peak cooling loads in buildings. In the case of ceiling passive energy aids, at present, a commonly used technology is ice or chilled water storage. Ice or chilled water storage is: Complex, requires specialized air-conditioning equipment and system, expensive, and generally applied to larger buildings or spaces/centers. Phase change ceiling tile on the other hand: operatives on a passive basis, can be used in any size building, is handily installed, can be used in retrofit applications.

One can readily appreciate the many fundamental distinguishing features of the tile structures of the invention from conventional tiles used as flooring, ceiling, bath/sink/shower, countertops, and walls.

### SUMMARY OF THE INVENTION

It is a primary object of this invention to provide agglomerate tile structures and ceiling tile structures. The agglomerate tile structures can be of a single layer having an intermixed granular base medium comprised of one or more granular-sized stone material (e.g., powdered, crushed, chips, and/or other broken pieces of varying sized particles, of quartz, granite, limestone, marble, glass, ceramic, semiprecious stones, etc.), plus a binder material and a PCM component; or the agglomerate tile structures can be of multiple layers, such as having an outer wear-layer substantially absent of PCM component—this outer wear-layer being bonded or otherwise incorporated with a second layer comprised of a binder material and a PCM component, substantially absent of the granular base medium. While applicants contemplate that the tile structures can be of a myriad of shapes and sizes, and associated features of the apparatus will be accordingly sized and fabricated of material(s) suitably compatible, traditionally-shaped generally planar tiles as well as tiles having curvilinear surfaces, may be fabricated according to the invention.

As one will readily appreciate in connection with the instant technical disclosure, applicants have identified unique tile structures, targeted for use as building products and employed as agglomerate tile flooring, ceilings, walls, decorative agglomerate tile water-barriers for sinks/showers and countertops, and so on. Depending upon end-use (flooring, ceiling, wallboard, water barrier, countertop), a tile structure of the invention preferably has sufficient structural integrity, flexural and compressive strength, while exhibiting an energy storage capacity (thermal properties) to assist with the passive heating and cooling of a space, to maintain a desired ambient temperature. According to the invention, the PCM in the tile structure is selected such that it will undergo a phase change at a preselected temperature of interest. For example, a microencapsulated paraffin wax-type PCM, such as encapsulated octadecane (of varying grades/content, by weight), and solid-state PCMs, which undergoes phase change (the PCMs ‘transition temperature’) at around room temperature ˜80° F. (27° C.), makes these PCMs useful for thermal regulation/passive solar applications of tile structures used in living spaces (residences, commercial buildings, including centers for sports-training, entertainment, events/activities, and so on). Another advantage paraffin wax PCM has over solid-state PCM is in binder selection. Encapsulated paraffin wax bonds with quartz chips using a polyester resin, which significantly reduces the overall cost of tile structures. If a solid-state PCM is used, it is preferable to use an epoxy for the binder; epoxy binders can run twice the cost of polyester binders. Various other types of PCMs are listed in Table 1, by way of example.

TABLE 1
Thermal Properties of Various Phase Change Materials

| | Transition | | |
|---|---|---|---|
| Material | Temperature | Heat of Fusion | Density |
| Solid-State PCM | | | |
| Pentaerythritol (PE) | 370.4° F. (188° C.) | 269 J/g (115 Btu/lbm) | 1390 kg/m³ (86.8 lb/ft³) |
| Pentaglycerine (PG) | 192.2° F. (89° C.) | 139 J/g (59.8 Btu/lbm) | 1220 kg/m³ (76.2 lb/ft³) |
| Neopentyl Glycol (NPG) | 118.4° F. (48° C.) | 119 J/g (51.2 Btu/lbm) | 1060 kg/m³ (66.2 lb/ft³) |
| 60% NPG and 40% PG | 78.8° F. (26° C.) | 76 J/g (32.7 Btu/lbm) | 1124 kg/m³ (70.2 lb/ft³) |
| Normal Paraffin | | | |
| Tetradecane C₁₄ | 41.9° F. (5.5° C.) | 228 J/g (98 Btu/lbm) | 825 kg/m³ (51.5 lb/ft³) |
| Hexadecane C₁₆ | 62.1° F. (16.7° C.) | 237 J/g (102 Btu/lbm) | 835 kg/m³ (52.1 lb/ft³) |
| Octadecane C₁₈ | 82.4° F. (28.0° C.) | 244 J/g (105 Btu/lbm) | 814 kg/m³ (50.8 lb/ft³) |
| Eicosane C₂₀ | 98.1° F. (36.7° C.) | 244 J/g (105 Btu/lbm) | 856 kg/m³ (53.4 lb/ft³) |
| Outlast | | | |
| Kenwax 18 | 88.2° F. (31.2° C.) | 165 J/g (71 Btu/lbm) | 765 kg/m³ (47.8 lb/ft³) |
| Kenwax 19 | 98.2° F. (36.8° C.) | 151 J/g (65 Btu/lbm) | 811 kg/m³ (50.6 lb/ft³) |

The unique agglomerate tile structures of the invention comprise: an amount of a granular base medium having one or more subcomponents selected from a wide variety of hard materials such as granular-sized stone (including, for example, powdered, crushed, chips, and/or other broken pieces of varying sized particles, of quartz, granite, limestone, marble, glass, ceramic, semiprecious stones, and so on); a binder material; pigment, if any; catalyst and wetting agent for the binder, if any; and a PCM component, such as microencapsulated PCMs. In one characterization of the agglomerate tile structure of the invention, the tile structure comprises: at least 10% by mass of binder material, at least 12% by mass of a PCM component, and at least 30% by mass of granular base medium (of one or more size-types of stone), whether or not other components are added (e.g., pigment, catalyst, fillers of synthetic materials etc.) to achieve visual/ornamental and/or special wear criteria. By way of example only, Table 2 illustrates two examples identified as Tile 1, polyester resin binder 12.1% by mass, 15.7% by mass of PCM, and granular base medium (of a couple of different sized granular quartz); and Tile 2, 20.0% by mass of PCM, 20.1% by mass of resin binder, and granular base medium (of a couple of different sized granular quartz). Resin content plays an important role in retaining suitable structural strength of the tile structures. The addition of more PCM plays a role in reducing structural properties of the tile structures. Tile 1 has a flexural strength approximately 1½ times greater than a typical ceramic tile with no PCM (ceramic tile having a flexural strength of ˜7.3 Mpa). Where resin binder content is lowered, the tile structure (see Table 2, Tile 1) may have a lower production cost.

TABLE 2
Composition and Physical Properties of
Example Agglomerate Tile Structures

| | Tile 1 | Tile 2 |
|---|---|---|
| Polyester Resin Mass Fraction | 12.1% | 20.1% |
| Quartz 34 Chips Mass Fraction | 41.1% | 13.1% |
| Quartz Powder Mass Fraction | 7.2% | 22.9% |
| PCM Mass Fraction | 15.7% | 20.0% |
| Expected Flexural Strength (S) | 11.2 MPa | 8.1 MPa |
| Expected Compressive Strength (C) | 31.43 MPa | 29.13 MPa |

In a second characterization of the agglomerate tile structure of the invention, the tile structure comprises at least an outer-wear agglomerate tile layer absent an intermixed PCM component, bound to a second, thicker layer, substantially absent the intermixed granular base medium. The second layer preferably comprises: at least 10% by mass of a binder material plus at least 20% by mass of a PCM component, and substantially absent of granular base medium. By way of example only, the PCM component of the second layer may be up to 90% by mass, with binder material taking up the remaining 10%. In the event the PCM component is selected to be <90% by mass, additional binder material and/or other materials may be added (e.g., pigment, binder catalyst, etc.) to achieve visual/ornamental effects and special wear criteria (e.g., tile is used in an outdoor patio, exposed to inclement weather).

A second aspect of the invention includes unique tile structures for use in ceilings and walls. This tile structure comprises a base support member having oppositely facing outer surfaces. From one of the outer surfaces, a plurality of fin protrusions extend; these protrusions are comprised substantially of a binder material intermixed with a PCM component. The base support material may be made of a conventional ceiling tile, such as acoustical tile, metal, wood or other suspended ceiling product, and in the case of vertical walls, conventional drywall/gypsum board, and so on. Fin protrusions may take on a variety of shapes, such as pin fin shaped, conical/cylindrical, tube-fin shaped, straight/rectangular, square pin shaped, circular/curvilinear, as well as irregular shapes. Fin protrusions may be mixed and molded prior to bonding to the outer surface using suitable thermal bonding or bonding agents/adhesives, or using spray-on techniques (e.g., similar to the construction technique employed by those who install drywall to spray-on texturing prior to applying a primer and paint); or fin protrusions may be mixed and molded or otherwise fabricated as integral with the outer surface when the base support member is made, using suitable fabrication techniques. If fabricated separately and bonded with the outer surface, suitable bonding agents/adhesives include those compatible with the type of material selected for the tile structure. Depending on available surface are of the support member's outer surface from which the fin protrusions extend, a multitude of the fin protrusions are preferably distributed thereon (whether randomly, as would be the case if sprayed-on, or in a pattern, as would be the case where elongated straight fins (see FIG. 7) extend in parallel across the outer surface. Once again, PCM and binder material may be selected from a variety of those available: microencapsulated PCM or solid-state PCM. One PCM component suitable for intermixing to form fin protrusions, is paraffin encapsulated in melamine-formaldehyde resin (a thermoset plastic). By way of example, fin protrusions preferably comprise: at least 20% by mass of binder material and at least 20% by mass of a PCM component. By way of example only, the PCM component of fin protrusions may be up to 80% by mass, with binder material taking up the remaining 20%. In the event the PCM component is selected to be <80% by mass, additional binder material and/or other materials may be added (e.g., pigment, binder catalyst, etc.) to achieve identified design criteria.

The tile structures are preferably made of material components providing sufficient structural integrity, including flexural and compressive strength for supporting intended loads, depending upon intended end use and anticipated wear and tear. As identified, a multitude of material components are contemplated for use according to the invention. As one will appreciate, certain of the several unique features, and further unique combinations of features, as supported and contemplated in the instant technical disclosure may provide a variety of advantages; among these include: (a) Design flexibility and versatility—basic structure is adaptable for use in a variety of applications, taking the form of a variety of shapes and sizes; (b) reduction of energy consumption in maintaining desired ambient temperature of a space, which may result in a substantial cost savings over time, with the inclusion of a PCM component in the tile structures as disclosed herein; and (c) installation is handy—traditional techniques currently used for installing flooring, ceiling, water-barrier tiling (bathroom, kitchen, sunroom, etc.), and so forth, may be employed. These and other advantages of providing the new tile structures and associated method of producing such structures, will be appreciated by perusing the instant technical discussion, including the drawings, claims, and abstract, in light of drawbacks to existing tile building materials that have been identified, or may be uncovered.

### BRIEF DESCRIPTION OF THE DRAWINGS

For purposes of illustrating the innovative nature plus the flexibility of design and versatility of the preferred tile structures supported and disclosed hereby, the invention will be better appreciated by reviewing the accompanying drawings (in which like numerals, as included, designate like parts). The drawings have been included to communicate and demonstrate, in pictorial fashion, the unique features of the innovative structures of the invention by way of example, only, and are in no way intended to unduly limit the disclosure hereof.

FIGS. 1A-1B depict an agglomerate tile structure of the invention containing a binder material, PCM component, intermixed with a granular base medium.

FIGS. 2A-2C are photomicrographs of a top surface (40×+ resolution) of agglomerate tile structures of the invention: FIGS. 2A and 2C are of a surface of a tile structure having PCM intermixed with a binder material and a granular base medium; FIG. 2B is of a tile structure having PCM but absent granular base medium (e.g., see layer 35, FIG. 3). In each figure within the white circle, one can see a few PCM microcapsules.

FIG. 3 is an isometric view of a multi-layer tile structure of the invention.

FIG. 4 is a schematic sectional view of a living space within the agglomerate tile structure(s) 10 has been installed as flooring, ceiling tile(s) 40 has been installed defining the lower edge of ceiling plenum 45, and wall tile(s) 140 has been installed defining vertical edge walls of wall plenum 145.

FIGS. 5A-5C depict the molecular structures of three solid-state type PCMs as labeled: pentaerythritol, pentaglycerine, neopentyl glycol.

FIG. 6 depicts the molecular structure of melamine-formaldehyde.

FIG. 7 depicts several known shapes used as fins, by way of example.

FIG. 8 is a schematic isometric view of a ceiling tile structure according to the invention.

### DETAILED DESCRIPTION OF EMBODIMENTS DEPICTED IN DRAWINGS

In connection with discussing the unique features depicted in the figures, occasional reference will be made back-and-forth to other of the figures which detail core, as well as further unique and distinguishing features of tile structures of the invention—demonstrating the flexibility of design of the invention. The agglomerate tile structures are especially suitable for flooring, as one target use, these tile structures are adaptable for sizing and use as decorative wall tiles, water-barrier tiles (e.g., lining showers, sinks, tubs, pools, ponds or landscape fountains, etc.), countertops (bathroom, sunroom, kitchen, greenhouse), and patios/decks. The ceiling tile structures are likewise adaptable for other uses, such as in or behind walls (e.g., office cubical barriers, outer walls of buildings in climate regions that have significant sun exposure and wide temperature fluctuations during the day, day to day, and so on) where circulation or re-circulation air plenums are present behind the wall for an exchange of air.

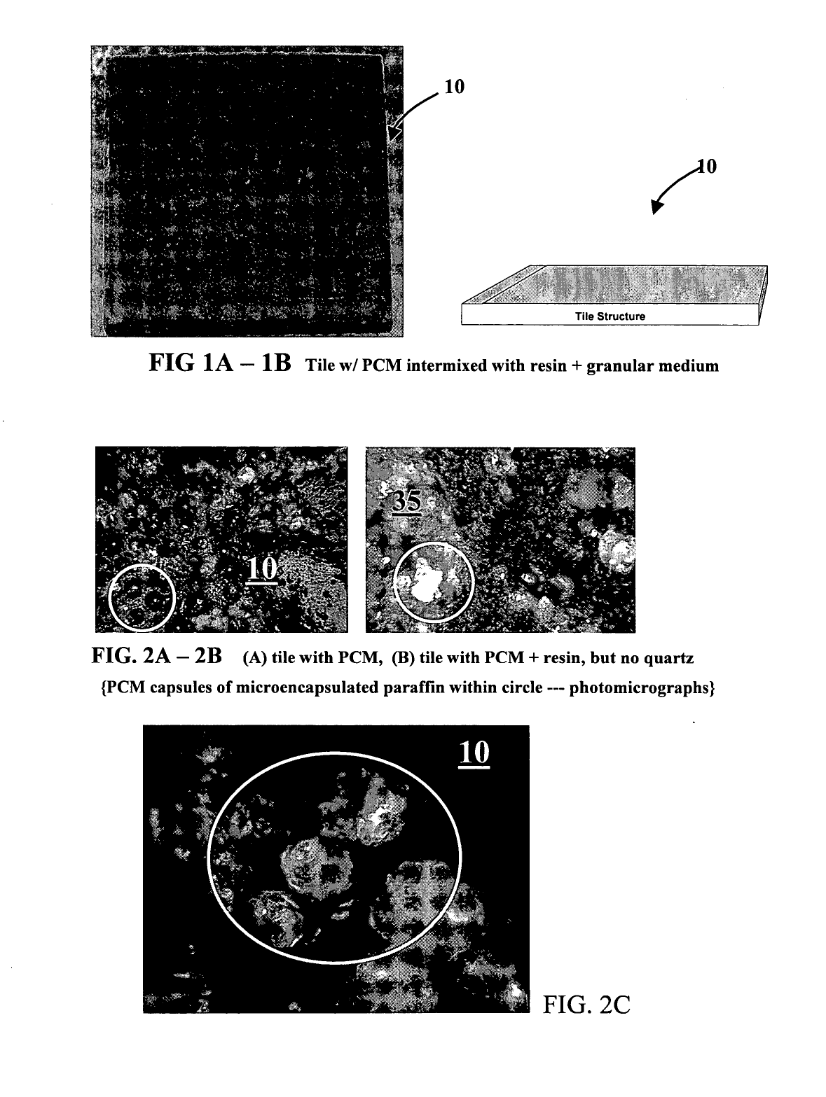

While the agglomerate tile structure 10 of the invention fabricated of intermixed materials in FIGS. 1A-1B is generally square, as mentioned, one will appreciate that the tile structures of the invention may be fabricated into a myriad of shapes and sizes. Associated features of the tile structures will be accordingly sized and fabricated of suitable, compatible material(s). The agglomerate tile structure 10 preferably comprises (a) at least 10% by mass of a binder material; (b) at least 12% by mass of a phase change material (PCM) component; and (c) at least 30% by mass of a granular base medium comprising at least one granular-sized stone. The phase change material (PCM) component is preferably a microencapsulated paraffin wax or a solid-state PCM. Combinations or a mixture of PCM may be used where each component is selected for its compatibility with other components of the tile structure, the binder material and the type of granular-sized stone selected for use. Many types of stone are suitable, including quartz, granite, limestone, marble, glass, ceramic, semiprecious stones, and so on. The granular sizes suitable for use include powdered, crushed, chips, and fragments of stone. Suitable binder material can include polyester binders and epoxies.

An agglomerate tile structure 10 that contains a PCM component of octadecane microencapsulated within a thermoset plastic (such as a melamine-formaldehyde resin), and a polyester binder intermixed with a granular base medium of two sizes of stone, for example, powdered quartz, crushed quartz, chips of quartz, and/or fragments of quartz (e.g., chips of quarts plus powered quarts), produces a tile structure suitable as flooring in a number of indoor and outdoor environments, according to the invention.

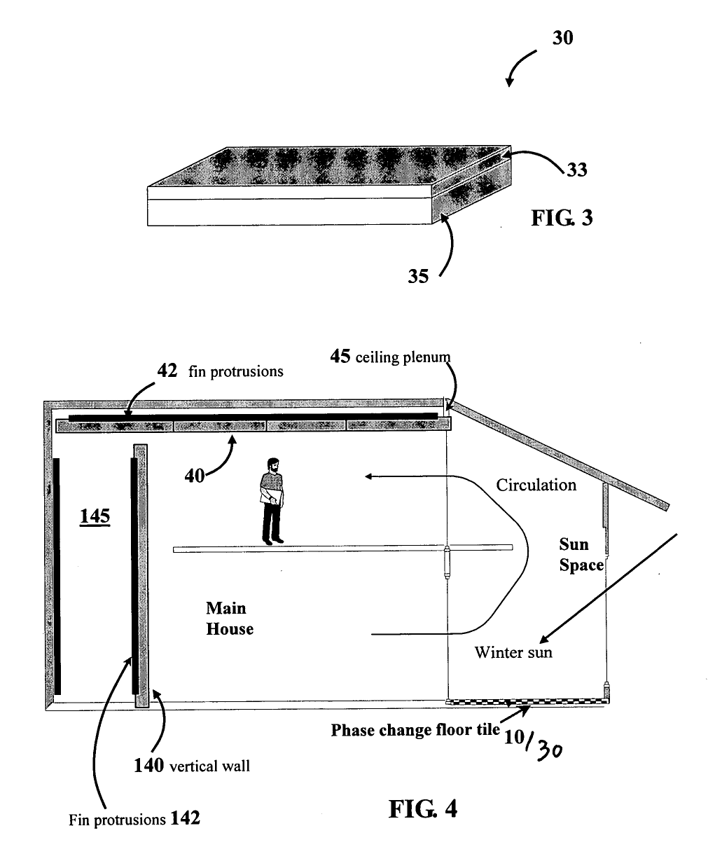

The photomicrographs labeled as FIGS. 2A-2C depict the outer surfaces of tile structures 10 (FIGS. 1A-1B) and 35 (the ‘bottom’ or lower layer of the multi-layered agglomerate tile structure labeled 30, in FIG. 3). FIGS. 2A and 2C are of a surface of a tile structure having PCM intermixed with a binder material plus a granular base medium (comprised of two different sizes of granular stone, e.g., chips and powdered quartz), such as the tile structure labeled 10 in FIGS. 1A-1B. One can see ‘bubble’ shapes at the surface of the layer 10 (see phtotomicrographs, FIG. 2A and its closer-in view, FIG. 2C) due to the PCM component comprised of microencapsulated paraffin wax, several such bubble shaped have been encircled in white.

The agglomerate tile structure 30 of FIG. 3 is fabricated of at least an outer layer 33 suitably bonded to a second layer 35. The surface of layer 35 is pictured in FIG. 2B, a layer generally absent granular base medium. Layer 35 preferably comprises at least 20% by mass of a binder material, at least 20% by mass of a phase change material (PCM) component, and is generally absent of a granular base medium. The outer layer 33 is preferably fabricated substantially according to traditional/conventional tile mixture components; for example, layer 33 may comprise at least 10% by mass of a binder material and at least 40% by mass of said granular base medium, plus pigment, and or a binder catalyst, and generally absent of a PCM component. Fabrication of the multi-layered structure 30 can create a thin transition-bond layer disposed between outer layer 33 and layer 35 with a substantial PCM component: Where each layer is initially intermixed separately, a mold of desired end-shape is filled with bottom layer 35 mixture, then a desired thickness of outer layer 33 mixture is layered atop—then the two layers of mixture molded/cured—the transition-bond layer will likely be composed of binder material along with trace/small amounts of PCM and/or granular base medium. Alternatively, multi-layer tile structure 30 may be fabricated such that each layer 33, 35 is separately mixed, molded and cured, and then inter-bonded together with suitable bonding agent/adhesive compatible with the traditional agglomerate tile outer layer 33 and adjacent layer 35.

A multi-layer agglomerate tile structure such as is represented in FIG. 3 at 30, is ideal for use as indoor flooring (see, for example, the schematic of a building in FIG. 4, at 10/30) or outdoor flooring, as the outer layer 33 may be fabricated to meet wear criteria, while adjacent layer 35 need not include granular base medium. By way of example only, lower layer 35 may be comprised of a polyester binder material intermixed with octadecane microencapsulated within a thermoset plastic such as melamine-formaldehyde resin (molecular structure depicted in FIG. 6, for reference); and outer layer 33 may be fabricated according to conventional agglomerate tile construction techniques comprising a granular base medium of one or more sizes of quartz, granite, limestone, marble, glass, ceramic, and semiprecious stones.

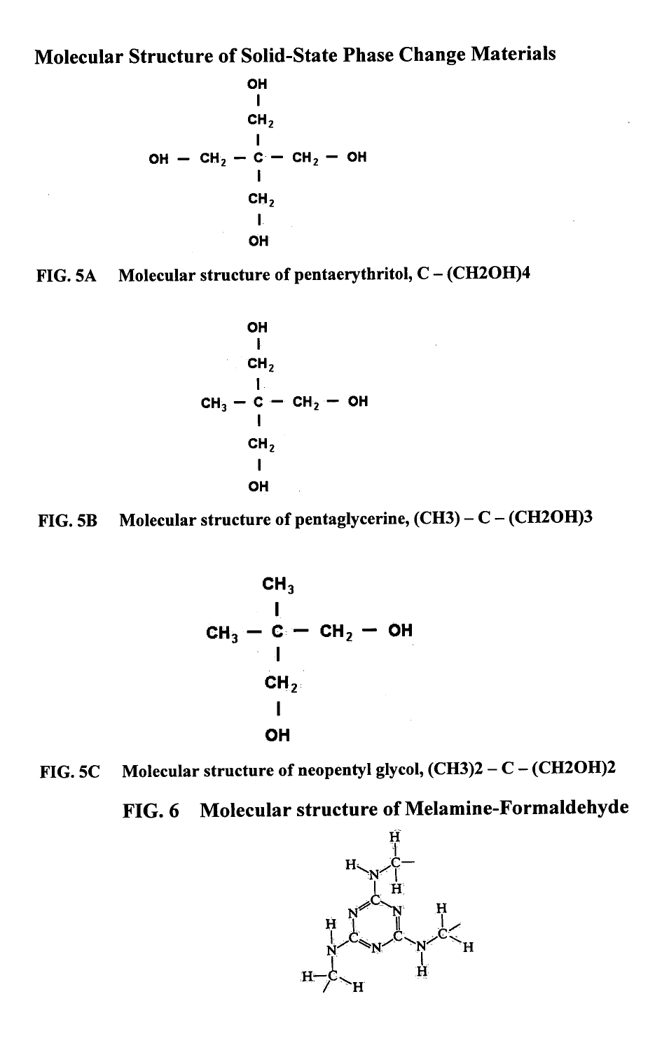

By way of reference, and example only, the molecular structure of several different solid-state PCMs are depicted and labeled as FIGS. 5A-5C

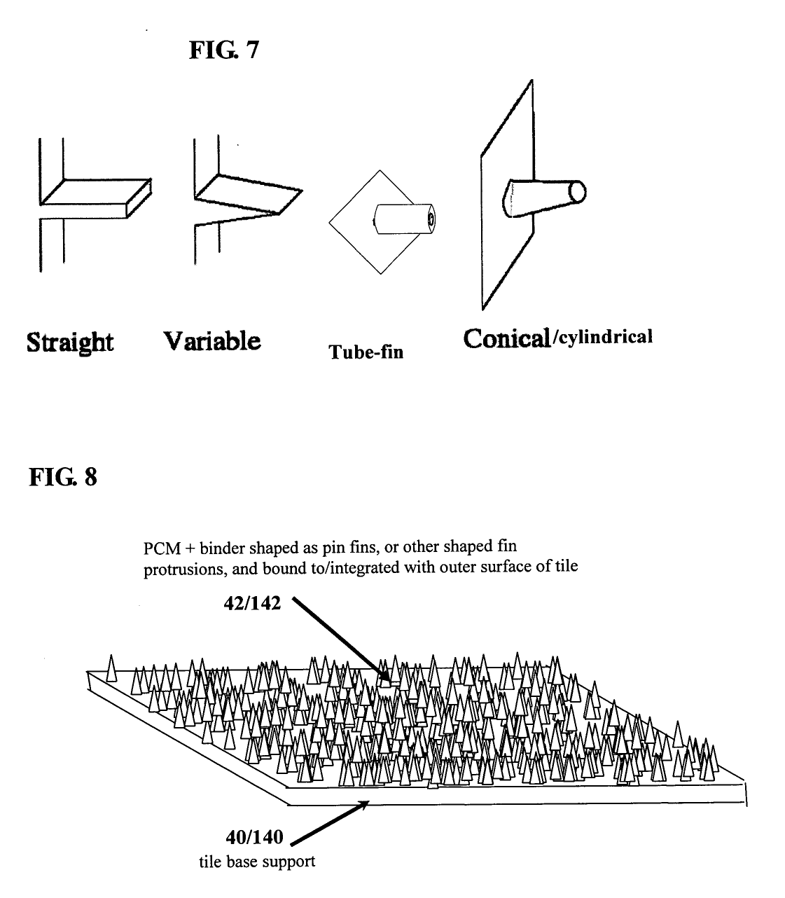

Turning next to FIGS. 7 and 8, a unique tile structure for use in ceilings and walls is shown. This tile structure has a base support member 40/140 having oppositely facing outer surfaces. From one of the outer surfaces, a plurality of fin protrusions extend 42/142; these protrusions are comprised substantially of a binder material intermixed with a PCM component. Please see, also, FIG. 4 for one example of indoor use of this unique tile structure. As mentioned above, the base support material 40/140 may be made of a conventional ceiling tile, such as acoustical tile, metal, wood or other suspended ceiling product, and in the case of vertical walls, conventional drywall, gypsum board, acoustic temporary walls (e.g., employed to define office cubicles within larger office spaces), and so on. Fin protrusions may take on a variety of shapes, such as pin fin shaped, conical/cylindrical, tube-fin shaped, straight/rectangular, square pin shaped, circular/curvilinear, as well as irregular shapes. Examples of known fin protrusion shapes include those depicted, by way of example, in FIG. 7.

Fin protrusions 42/142 may be mixed and molded prior to bonding to the outer surface using suitable thermal bonding or bonding agents/adhesives, or using spray-on techniques (e.g., similar to the construction technique employed by those who install drywall to spray-on texturing prior to applying a primer and paint). Alternatively, fin protrusions 42/142 may be mixed and molded or otherwise fabricated as integral with the outer surface when the base support member 40/140 is made, using suitable fabrication techniques. If fabricated separately and bonded with the outer surface, suitable bonding agents/adhesives include those compatible with the type of material selected for the tile structure. Depending on available surface are of the support member's outer surface from which the fin protrusions extend, a multitude of the fin protrusions are preferably distributed thereon (whether randomly, as would be the case if sprayed-on, or in a pattern, as would be the case where elongated straight fins (see FIG. 7) extend in parallel across the outer surface. Once again, PCM and binder material may be selected from a variety of those available: microencapsulated PCM or solid-state PCM. One PCM component suitable for intermixing to form fin protrusions, is paraffin encapsulated in melamine-formaldehyde resin (a thermoset plastic). By way of example, fin protrusions preferably comprise: at least 20% by mass of binder material and at least 20% by mass of a PCM component.

Returning to FIG. 4, the drop ceiling is composed of tile structures having a base 40 with fin protrusions 42 extending upwardly into ceiling plenum 45. The vertical wall depicted having plenum 145 defined by tile structures of a base 140 and fin protrusions 142 functions, similarly. In drop ceilings, return air from the room(s) ‘main house’ often passes between the drop ceiling 40/42 and the floor or roof above on its way from the room to the air conditioning (AC) unit. Here, the room is cooled down slightly at night—e.g., 5 degrees—when utility rates are low(er). Doing so solidifies the PCM, storing “colth.” During the day, ambient air in the room (upper floor of the ‘main house’) is permitted to warm-up slightly (72 F, or so) and the return air now is cooled as it passes over the melting PCM on its way back to the air-conditioning unit, thereby reducing the peak amount of cooling supplied by the AC unit.

The tile structures 40/42 and 140/142 (FIG. 4) of the invention store thermal energy. An example of an application is the reduction of peak cooling loads which are often the cause of peak electrical demand. In this proposed application, air from the room is returned through a ceiling plenum 45 above the ceiling tile to an air-handling unit (not shown, for simplicity) providing air-conditioning for the space. At night the room (‘main house’) is cooled to a cooler temperature, ˜70 F. At this temperature the PCM solidifies releasing heat which is removed by the air-conditioner or by cool night air. During the day, the room is held at a slightly warmer temperature, ˜75 F. The air in the room is returned through the ceiling plenum and melts the phase change material. In this process the air is cooled and the phase change material absorbs energy thereby reducing the load on the air-conditioning unit and its concomitant demand for electric power. Peak air-conditioning power requirement may be reduced by ˜20% or more, depending on the amount of PCM used. Since microencapsulated PCM has an average size of ˜10 microns, it is suitable for mixing with a binder and molding into any desirable shape. In FIG. 8, by way of example, a pin fin shape is depicated to promote heat transfer by maximizing surface area available for convective heat transfer. A host of other shapes are contemplated based upon desired heat transfer rate. As mentioned, preferably the space is held or permitted to remain at a slightly lower temperature during the nighttime hours, ˜5-degrees (outside ambient air temp is expected to drop, anyway; thus, permitting the indoor space to cool does not increase cooling energy consumption, much if at all).

### BACKGROUND

By way of background, ‘active solar’ systems include the use of collectors and storage systems that are not integrated with the building structure, while ‘passive solar’ systems are integrated within the building structure. One goal of the example representative structures described below is to increase efficiency of passive solar applications by enhancing the energy storage. The thermal storage capacity of the representative floor tile was increased with the addition of phase change materials, according to the invention. Traditional passive design often involves the addition of a sunspace (e.g., see FIG. 4) to a building. The purpose of this room is to collect and store solar energy during the day and subsequently release the energy at night to reduce the heating load. Floors and walls traditionally make up the thermal mass of a sunspace. Typically construction materials are concrete, masonry brick or dark clay tile. Heat is stored as the material temperature increases due to the solar energy entering the space. As a result, the space can easily become overheated. Solutions to prevent overheating can be accomplished in several ways. The south-facing glazing area can be decreased or an overhang can be placed over the south facing glazing to reduce the amount of direct sunlight entering the space during the summer months. Installation of fans for increased ventilation and circulation can also aid in reducing overheating. Another solution is to incorporate latent heat storage.

Heat is released during a change in phase of a material. All materials undergo phase transitions, thus have an associated latent heat. When a substance melts, vaporizes and sublimates, heat is absorbed. Heat is released when a material solidifies or condenses. During a change in phase, the temperature remains nearly constant. According to the invention, PCMs have been incorporated into tile structures for targeted use in passive applications. Wood, gypsum board, lightweight concrete, and agglomerate and other floor tile may be enhanced with the addition of phase change materials.

One conventional/traditional agglomerate floor tile consists of quartz chips, quartz powder (filler), dyes, and a polyester binder. Using conventional techniques, the tile components are mixed in a large mixer that looks like a cement mixer. The mixture, appearing and feeling much like damp sand, is placed in a vibrating vacuum assembly to remove all air and to compress the material. Next, the slabs of material are heated to cause catalysis. After curing, slabs are cut and polished to produce the desired tiles. Because agglomerate floor tiles have exceptional wear resistance properties, they are often marketed to institutional clients that have high traffic areas. Residential applications (sun rooms or other areas that receive direct sunlight) do not have the traffic of for example, an airport concourse. The challenge is to maximize thermal storage capacity using phase change materials, while maintaining sufficient physical properties.

1. Phase Change Materials (PCMs)

All materials have an associated latent heat for each phase change, but only a few are appropriate for passive solar applications. Desirable characteristics include: a reversible transition, a high latent heat, small changes in volume between phases, low vapor pressure, generally chemically stable, and good heat conductors. These properties also have to occur at the appropriate transition temperature. Depending on the passive application, the required transition temperature will vary. For a sunspace, for example, target is roughly 27° C. (80° F.). During the ‘heating season’ in the Northern Hemisphere—where living space is heated—the nights are longer than daylight hours. An optimal transition temperature is one-third of the way between the lowest tolerable temperature and the highest tolerable temperature of the space.

Traditional phase change materials include alkanes, paraffin waxes and salt hydrates. These materials undergo a reversible solid to liquid phase change at various transition temperatures. ‘Solid-state’ phase change materials are those that change from amorphous to crystalline phases while remaining ‘solid.’ Both paraffin wax and salt hydrates typically require encapsulation to contain the liquid phase, which adds to final cost of this PCM. Salt hydrates are inorganic materials. Inorganic compounds have twice the volumetric latent energy storage compared to organic compounds. The organic compounds however, have the advantages of melting congruently and are non-corrosive. Salt hydrates will melt incongruently causing phase separation. There are two categories of solid-state phase change materials: layered perovskites and plastic crystals. The transition temperature of solid-state phase change materials in a pure form runs on the higher side for use in passive applications. By mixing these compounds in various ratios, the transition temperature can be lowered. A preferred ratio was determined to be a mixture of 60% neopentyl glycol and 40 % pentaglycerine.

1.1 Layered Perovskites

Layered perovskites are chemical compounds with the general formula of:

(n-Cₙ H₂ₙ₊₁ NH₃)₂MCL₄

Where:

M=is a divalent metal atom such as Mn, Cu, Hg or Fe.

n=8≦n≦18

The structure is composed of regular alteration of inorganic and hydrocarbon regions. Each inorganic layer is sandwiched between two hydrocarbon layers. The hydrocarbon regions are composed of long chain alkylammonium groups ionicly bonded to the inorganic support. These linear alkyl chains are responsible for the thermal behavior of the material.

At low temperatures the alkyl chains are in an ordered planar zigzag arrangement. The chains are in a disordered state at high temperatures. They exhibit “liquid-like” behavior in this state. A liquid phase is not obtained at this point because the alkyl chains are fixed on one end to the inorganic layer, thus keeping its lattice structure. One advantage is that transition temperatures are dependent on alkyl chain length so control of transition temperatures can be accomplished. Other advantages are a relatively high thermal conductivity and chemical stability at high temperatures. Disadvantages include possible toxicity, lower value of enthalpy per unit cost and less total latent heat due to the inorganic regions of the molecules that are inert.

1.2 Plastic Crystals

NASA studied a group of solid-state materials during the 1970's for passive temperature control of earth satellites. Three materials were shown to be promising for passive applications: pentaerythritol (PE), pentaglycerine (PG) and neopentyl glycol (NPG). These materials belong to a class of compounds called polyalcohols or polyols. Each molecule has a central carbon atom with four attached carbon atoms forming a tetrahedron. The number of hydroxyl groups attached to the four carbon atoms distinguished the three compounds from each other. Pentaerythritol is the largest molecule, the smallest is neopentyl glycol. Molecular structures of these materials are presented in FIGS. 5A-5C, for reference. The most stable form of these materials is a crystalline solid. As heat is applied the material undergoes a transition to a plastic crystal. This behavior comes from the tetrahedral molecular shape and the hydrogen resonant bonding that occurs between neighboring molecules. The substance will eventually melt as the temperature is further increased and will eventually turn into a gas. It is the transition from crystalline solid to a plastic crystal that is of interest.

Plastic crystals are defined as a type of mesophase. The term mesophase is shortened from mesomorphic: a phase with microscopic structures between solids and ordinary isotropic liquids. The difference between the three types of mesophases is the type of disordering they display. Liquid crystals exhibit a positional disordering. Plastic crystals show positional disordering but also display orientational disordering. A final type, condis, displays conformational disordering as well as positional and orientational disordering. In positional disordering, the intermolecular distances become less uniform and the molecules can arrange themselves in parallel, perpendicular to each other or randomly. Conformational disordering is the acquisition of freedom of executing rotations about single bonds.

1.3 Paraffin Wax(es)

Normal paraffin waxes are part of a family of saturated hydrocarbons. The structure is the type CₙH₂ₙ₊₂. Those with carbon atoms between five and fifteen are liquids at room temperatures and are not considered. Normal or straight chain and symmetrically branched chain paraffin waxes are the most stable. Typically, paraffin waxes with odd numbers of carbon atoms are more widely used because they are more available, more economical and have higher heats of fusion. Paraffin waxes are composed mainly of alkanes, approximately 75%. Alkanes and paraffin waxes are both organic compounds. Paraffin can contain several alkanes resulting in a melting range rather than a melting point. As the molecular weight increases, the melting point tends to increase as well. Using different mixtures of alkanes, specific transition temperatures for paraffin waxes can be attained. Paraffin waxes and alkanes at the transition temperature melt to a liquid and solidify upon cooling. They do not have the containment problems of salt hydrates.

The properties of normal paraffin wax are very suitable for latent heat storage. They have a large heat of fusion per unit weight, they are non-corrosive, nontoxic, chemically inert and stable below 500° C. (932° F.). On melting, they have a low volume change and a low vapor pressure. Mixing different molecular weight paraffin waxes together can easily vary melting temperature. Since they are commercially available, the cost is reasonable. Prime candidates for passive applications are tetradecane, hexadecane, octadecane and eicosane. Paraffin wax has a low thermal conductivity. However, the addition of additives such as graphite could increase the thermal conductivity. A Boulder, Colorado company, Outlast Technology, distributes outerwear made of fabrics that incorporate encapsulated paraffin wax. The Outlast Technology fabric involves the microencapsulation of microscopic size droplets of paraffin wax. These encapsulated particles of wax are then incorporated into fabrics and foams that are used for lining materials.

Outlast Technology currently uses two grades of phase change materials in order to fit two different applications. One application is for cold weather/extremity wear designed to operate from 18.3° C. to 29.4° C. (65° F. to 85° F.). The other grade is used in four season applications designed to operate from 26.7° C. to 37.8° C. (80° F. to 100° F.). The grades are composed of a mixture of paraffin waxes from a carbon count of 15 to 24. A mixture is used in order to cut production costs. Pure forms of paraffin waxes are significantly more expensive due to the refining processes involved. Capsules are on the order of 21 μm. Using this process of microencapsulation and the appropriate mixture of paraffin, a suitable candidate can be found for the floor tile application.

Pure octadecane is very close to the defined ideal passive temperature. Outlast uses mixtures of normal paraffin wax, Kenwax 18 and 19, for the phase change material. The paraffin content of these two mixtures is listed in Appendix 2. By mixing normal alkanes of different molecule weights, the melting or transition temperature can be altered from that of the pure form. Kenwax mixtures experience a decrease, although not as drastic. Outlast determined that the latent heat of a blend can be found from a linear equation, presented as:

Final Blend J/g=(wt. % _{mPCM1}×J/g _{mPCM1})+(wt. % _{mPCM2}×J/g_{mPCM2})+ . . .

Octadecane in its pure form has a relatively high heat of fusion with a transition temperature close to an ideal passive temperature. Its latent heat storage is more than three times greater than the NPG/PG mixture. Based on thermal storage capabilities, octadecane is the superior material, followed by the Kenwax 18.

Paraffin wax and solid-state phase change materials show the behavior of under or super cooling. This behavior occurs when the material does not solidify at the same temperature at which it melted. Solid-state phase change materials have shown more than a twenty-degree difference. The difference is not as noticeable in paraffin waxes.

1.4 Energy Storage Capabilities of PCM

Based on the latent heat and the density of the phase change materials, the potential energy storage can be calculated. Assuming a floor tile composed of 100% phase change material, the energy storage per square area may be determined. Octadecane was found to have twice the potential energy storage of the solid-state phase change mixture. Kenwax 18 has one and one-half times more potential energy storage over the solid-state mixture. The microencapsulation shell is approximately one micron thick with the core taking 80-85% of the weight.

TABLE 3
Potential Energy Storage of 100% Phase Change Floor Tile

| Material | ½″ Floor Tile | ¾″ Floor Tile |
|---|---|---|
| 60% NPG/40% | 1.08 MJ/m² (95.6 Btu/ft²) | 1.63 MJ/m² (143.5 Btu/ft²) |
| PG | | |
| Kenwax 18 | 1.60 MJ/m² (141.4 Btu/ft²) | 2.40 MJ/m² (212.1 Btu/ft²) |
| Octadecane | 2.52 MJ/m² (222.3 Btu/ft²) | 3.78 MJ/m² (333.4 Btu/ft²) |

Table 3 shows the effect of a 15% to 20% reduction, or 80% to 85% of the initial values. Octadecane has a storage potential approximately twice as great as the solid-state phase change mixture. The effect on the Kenwax 18 is more noticeable. Its energy storage potential is still larger, but is more on the scale of the solid-state phase change mixture.

TABLE 4
Potential Energy Storage Adjusting for Encapsulation Shell

| Material | ½″ Floor Tile | ¾″ Floor Tile |
|---|---|---|
| Kenwax 18 | 1.28-1.36 MJ/m² | 1.92-2.04 MJ/m² |
| Octadecane | 2.02-2.14 MJ/m² | 3.02-3.21 MJ/m² |

2. Binder Materials

2.1 Selection of a Binder for Solid-State Phase Change Materials

An unsaturated polyester, with styrene as a liquid monomer, was used as the binder. In this case, the tile mixture did not cure when the solid-state phase change material was added. PCM may have prevented the cure. Polyesters use carboxylic acids and polyfunctional alcohols like neopentyl glycol, to impart flexibility, toughness and stain and chemical resistance. Neopentyl glycol is often used in the polyester synthesis for improved stain and chemical resistance. Propylene glycol is typically used with the unsaturated monomer styrene. Thus, with the addition of neopentyl glycol and pentaglycerine, cross-linking may have been prevented in this case.

Epoxies were explored as binder candidates for solid-state phase change materials. An epoxy resin and curing agent produced by Shell Chemicals was the second binder tested. EPON 828 and curing agent 3140 was combined with the phase change materials and quartz. This mixture did cure to form a piece of prototype tile. The amount of phase change material was small, but DSC runs did show a phase transition at the appropriate transition temperature. EPON 828 is an undiluted clear difunctional bisphenolA/epichlorohydrin derived liquid epoxy resin. This material is cross-linked with an appropriate curing agent to form a material with good mechanical and chemical resistance properties. The curing agent 3140 is a low viscosity reactive polyamide and high imidazoline, which is based on dimerized fatty acid and polyamines. Solid-state phase change materials typically reacted adversely with the epoxy resin: The solid-state materials, NPG, PG, PE and the 60/40 NPG/PG mixture all have available hydroxyl groups to react with epoxy groups. The solid-state phase change material caused the rate of cross-linking to increase by acting like a curing agent. This resulted in a decrease in the thermal storage capability of the phase change material, since some of phase change material was being consumed during the cure.

2.2 Selection of a Binder for Paraffin Wax Phase Change Materials

Paraffin wax was found to not react adversely with epoxies or polyesters. The material used for the encapsulation is relatively inert. Outlast Technology uses melamine-formaldehyde as the encapsulation material and found it was durable and did not react adversely with other materials. Melamine-formaldehyde resin belongs to the family of thermosets. The high cross-linking nature of the cure product results in superior hardness, strength and rigidity. High chemical and abrasion resistance are other strong attributes of the material. It is widely used in decorative laminate such as Formica. The molecular structure is shown in FIG. 6, for reference. While sites can remain active if cross-linking is not complete, which may react with the tile binder, this is not anticipated as the encapsulation process is expected to cure completely. Costs of general purpose polyesters are roughly half that for epoxies.

TABLE 5
Binder Approximate Costs

| Binder | Price |
|---|---|
| Epoxy | |
| Basic grades | $1.30 to $1.50/lb |
| Specialty grades | $2.00 to $4.00/lb |
| Shell EPI-CURe 3140 | $1.65/lb |
| Shell EPI-CURe 3234 | $1.65/lb |
| Shell Resin 828 | $1.65/lb |
| Polyesters | |
| General purpose | $0.65 to $0.70/lb |
| Ashland chlorendic polyester HETRON 197-3 | $1.81/lb |
| Ashland isophthalic polyester AROPOL 7241 | $1.44/lb |

Where encapsulated octadecane is selected for the phase change material component, it was found that a polyester binder can be used. The polyester resin selected is a styrene-based resin that is used by agglomerate tile manufacturers. It requires heating to 80° C. to initiate the curing process. A curing agent is also used to aid the curing process. Room temperature and UV cured resins were researched as a possible replacement. The UV cured resins typically are used for coatings and do not possess the mechanical strength required for a floor tile application. Suitable room temperature cured resins were not found. A polyester resin that would gel at room temperature was evaluated, but it still required heating in order to reach full strength.

3. Tile Structures: the Mixture

One supplier of conventional agglomerate tiles is the Zodiaq Company, Thetford Mines, Quebec, Canada. The company was originally known as Granirex and, herein as occasionally referenced in connection with tile products, these are called the Granirex tile. The Granirex conventional recipe is composed of seven ingredients. A catalyst and wetting agent (silane) are added to the resin before the other components. The catalyst is 2% the weight of the resin and the silane is 1% of the weight. Table 6 lists the proportions of the components. The pigment used is carbon black.

TABLE 6
Granirex Recipe Proportions

| | Density | |
|---|---|---|
| Component | [g/cm³] | Mass Fraction F |
| Quartz Chips, Mesh 6 (q-6) | 2.65 | 0.048 |
| Quartz Chips, Mesh 10 (q-10) | 2.65 | 0.057 |
| Quartz Chips, Mesh 34 (q-34) | 2.65 | 0.411 |
| Quartz Chips, Mesh 84 (q-84) | 2.65 | 0.124 |
| Quartz Powder, Mesh 325 (powder) | 2.65 | 0.229 |
| Resin | 1.094 | 0.121 |
| Pigment | 1.75 | 0.010 |

Samples made that replaced 100% of the quartz powder with microencapsulated phase change material in the above recipe resulted in a suitable, successful cure. Where too little resin is used, the tile results in poor structural properties. By running the mixer at relatively high speeds, the microencapsulated phase change material was more-fully incorporated.

3. Testing of Example Tiles

Examples of tiles were test for properties: physical and thermal. Physical testing relates to capacity to withstand commercial floor tile use. Thermal analysis is done to determine the heat storage capability of the tile and to verify that transition occurs within the appropriate temperature range. Standard techniques exist for the physical testing typical of commercially available agglomerate floor tile.

Example tiles were fabricated with varying amounts of resin and phase change materials. All the tiles were made with a four-inch square mold. The mixture was added to the mold and pressed under 3,450-6,900 kPa (500-1000 psi) of pressure. While the mixture was still in the mold it was heated to approximately 85° C. (185° F.) for twenty minutes. After twenty minutes the tile was removed and the curing process was finished in an oven set to 100° C. (212° F.) for approximately four hours. This second heating in the oven was done to ensure that all the resin had cured. One method of determining this state was the lack of polyester odor from the tile.

Each example tile mixture was combined in a kitchen mixer. Catalyst and the wetting agent were added to the resin and these were mixed for 30 seconds. Quartz chips were then added and mixed for another minute. Next, quartz powder was incorporated into the mixture slowly. Once all the powder was added to the mixture, it was mixed for another two minutes. Tiles completed the curing process after resting for 24 hours at room temperature, after curing in the oven. At this point the tiles were cut to the appropriate sizes for testing, using a wet-saw with a diamond blade.

The compression test was performed on samples to gauge the bonding strength of the resin. The amount of resins required can be sensitive to humidity and the container used for mixing. The resin will wet the container, which leads to less resin being incorporated into the mixture. By increasing the binder resin mass fraction from 8% to 12%, a much wetter mixture was obtained. This resulted in a properly compacted and cured tile. Several other samples were made with resin amounts varying between 8% and 12%.

Initial testing of example tiles included performing a conventional/standard 3-point flexural test and compressive strength tests. Sixteen prototype tiles with varying amounts of phase change material (PCM), resin, quartz powder and quartz chips were fabricated according to the invention. Each tile was tested, and models were developed for both flexural and compressive strength. Models were used to predict the behavior of tile with varying PCM, resin and quartz content. The PCM, resin, quartz powder and quartz chips percentages for each prototype tile are listed in Table 7. The remaining components, pigment, quartz chips of mesh 6, 8 and 84 were kept constant for each prototype tile. Table 7 lists the mass percentage for these components. Compositions of the sixteen prototype tiles were selected using the concept of mixture design. In this case, the properties of interest are flexural and compressive strength. The ingredients are: PCM, resin, quartz powder and quartz chips mesh-34. The final goal was a tile with high physical strength and high PCM content. A typical ceramic tile was used as comparison for adequate physical strength.

TABLE 7
Mass Percentage of Four Variable Components
of Tiles Structure Examples

| | | % Mass | | % Mass of |
|---|---|---|---|---|
| | % Mass | of Resin | % Mass of | Quartz Chips |
| Prototype Tile | of PCM | [>10%] | Powder | Mesh 34 |
| 1 | 0 | 12.7 | 22.9 | 64.4 |
| 2 | 22.9 | 12.7 | 0 | 64.4 |
| 3 | 41.1 | 12.7 | 0 | 46.2 |
| 4 | 41.1 | 12.7 | 22.9 | 23.3 |
| 5 | 0 | 12.7 | 22.9 | 64.4 |
| 6 | 0 | 20.1 | 14.9 | 65 |
| 7 | 14.9 | 20.1 | 0 | 65 |
| 8 | 41.1 | 20.1 | 0 | 38.8 |
| 9 | 41.1 | 20.1 | 14.9 | 23.9 |
| 10 | 33.1 | 20.1 | 22.9 | 23.9 |
| 11 | 20.5 | 12.1 | 22.9 | 44.5 |
| 12 | 18.5 | 16.1 | 22.9 | 42.5 |
| 13 | 26.3 | 12.1 | 11.5 | 50.1 |
| 14 | 21.7 | 20.1 | 12.6 | 45.6 |
| 15 | 23.5 | 16.9 | 12.2 | 47.4 |
| 16 | 39.1 | 16.1 | 15.2 | 29.6 |

A basic 3-point bending test was employed to determine the flexural strength of prototype tiles. The equation used is given here:

$$S = \frac{3 PL}{2 {bd}^{2}}$$

Where:

S=flexural strength (MPa)

P=break load (N)

L=outer span (mm)

b=specimen width (mm)

d=specimen thickness (mm)

Testing was performed on an ATS 900 testing machine. A diagram of the setup is given in FIG. 8. Load is distributed at the three points shown in the diagram. The break load is measured when the sample fails and is used to determine the maximum flexural strength. Samples had the following dimensions:

b=8 mm

d=6 mm

L=80 mm

Loading was applied at a rate of 1.0 mm/min.

Data was collected for the sixteen prototype tiles and the following model was developed. The model was determined using a statistical analysis software tool called SAS. A basic quadratic model was initially fitted to the sixteen data points. This resulted in a ten-term quadratic equation. F-tests and p-tests were used to determine the significance of the original ten terms. Non-significant terms were dropped resulting in the three-term model presented below.

S=10^{(3.0x}^{₂}^{+13.9x}^{₁}^{x}^{₃}^{-4.7x}^{₂}^{x}^{₄₎}

Where:

S=flexural strength (MPa)

x₁=mass fraction of polyester resin

x₂=mass fraction of quartz chips of mesh 34

x₃=mass fraction of quartz powder

x₄=mass fraction of PCM

And:

x₁+x₂+x₃+x₄=1

The above model is valid for the following lower and upper limits of the four components, x₁, x₂, x₃ and x₄.

12.1%≦polyester resin≦20.1%

0%≦quartz chips of mesh 34≦41.1%

0%≦quartz powder≦22.9%

0%≦PCM≦41.1%

Goodness of fit for the model was based on R² values and standard errors on the estimates. These values are presented in the table below.

TABLE 8
Summary Statistics of Flexural Strength Model

| | |
|---|---|
| R² | 0.978 |
| σₓ₂ | 0.198 |
| σₓ₁ₓ₃ | 1.049 |
| σₓ₂ₓ₄ | 0.681 |

An R² value of unity indicates a perfect fit. Standard errors on the estimates were all within reason based on statistical significance. Significance was determined from t-tests. A t-score close to zero is considered to be significant. The t-scores for the above standard errors were all significant. Example tiles 1, 5 and 6 did not contain any phase change material, which corresponds to a high flexural strength. These also contain more resin by mass than the conventional Granirex tile fabricated to the Granirex recipe (accounting for the higher strength). Flexural strength decreases with increasing amounts of phase change material. It was also noted that with high phase change content, 41.1%, a high resin content resulted in a higher flexural strength. Further analysis of model behavior lead to the conclusion that at lower PCM content, approximately 18% or less, lower resin content resulted in a higher flexural strength. Higher PCM content, ˜18% or greater, requires a higher resin amount to reach higher flexural strength.

Samples were loaded between two platens to perform the compressive strength test. A diagram of the setup is given in FIG. 10. An MTS testing machine was used to perform all testing. Samples were 51 mm (two inches) square and 19 mm (¾-inch) thick. Loading was done at 0.05 in/min. At failure, the sample typically crumbled and cracked around the edges. The equation used to determine the compressive strength for each of the sixteen prototype tiles is:

C=W/A

Where:

C=compressive strength (Pa)

W=total load on specimen at failure (N)

A=calculated area of bearing surface (M²)

A basic quadratic was fit to the sixteen data points. Analysis of F-tests and p-tests resulted in a four-term linear model.

C=10^{(6.32x}^{₁}^{+5.22x}^{₂}^{+5.23x}^{₃}^{+2.37x}^{₄}^{+0.8385)}

Where:

C=compressive strength (kPa)

x₁=mass fraction of polyester resin

x₂=mass fraction of quartz chips of mesh 34

x₃=mass fraction of quartz powder

x₄=mass fraction of PCM

And:

x₁+x₂+x₃+x₄=1

The above model for compressive strength is valid for the following lower and upper limits of the four components, x₁, x₂, x₃ and x₄.

12.1%≦polyester resin≦20.1%

0%≦quartz chips of mesh 34≦41.1%

0%≦quartz powder≦22.9%

0%≦PCM≦41.1%

Goodness of the fit of the model was based on R² values and standard errors on the estimates. These values are presented in the table below.

TABLE 9
Summary Statistics of Compressive Strength Model

| | |
|---|---|
| R² | 0.999 |
| σₓ₁ | 0.546 |
| σₓ₂ | 0.178 |
| σₓ₃ | 0.272 |
| σₓ₄ | 0.194 |

An R² value of unity indicates a perfect fit. Standard errors on the estimates were all within reason based on t-tests performed to determine statistical significance.

[image]

Graph 1: Dependence of Flexural Strength on Resin Content when Quartz Chips Mesh 34 are Held Constant at 41.1%

The conventional Granirex tile fab process involves pressing the tile mixture and pulling a vacuum at the same time. Pulling a vacuum helps to increase density and fully incorporate all the components. Tiles made in the lab are pressed but not subjected to a vacuum.

Simulation studies were made of the potential energy savings associated with the application of phase change floor tiles applied to homes. A study was performed using the Building Loads Analysis and System Thermodynamic (BLAST) program, an internationally recognized program for estimating the annual energy consumption of buildings. A 2,400 square foot home, assumed to be built to a modern standard was simulated using climate data for Denver, Colo. Annual heating energy consumption was calculated for the house with and without phase change floor tile in the sunroom. Average natural gas prices at the end of last year's heating season were about $8 per 1000 cubic feet and the heating value of natural gas is about 1000 Btu per cubic foot. A seasonal furnace efficiency of 80 percent was assumed. Using these figures, the annual furnace energy consumption and annual heating bill can be estimated. As the table indicates, the annual energy cost avoidance of using phase change floor tile is $333. In the simulation model, excess heat storage capacity in the tile was assumed so that the upper limit of cost savings could be determined. Given nearly unlimited storage capacity, 43,900 MJ (41,590 kBtu) could be saved per year using phase change floor tile. However, using the current design, 19 mm thick (¾ inch) tile containing 20% phase change material in a home with a 32 sq meters (350 sq ft) sun room, the available heat storage per year, assuming an 8 month heating season is 6,417 MJ (6,082 kBtu). This would result in fuel cost savings of about $50 per year. Additional storage could produce additional savings. This can be achieved in a number of ways. A slightly larger sunroom would improve collection of solar energy and storage. In most sunrooms the north wall of the room is illuminated by the sun in the winter months and it could be covered with a PCM tile wainscot. The tile could also be made thicker, 25 mm or 1 inch for example. If the total area of a thicker tile were 40 square meters (431 square feet), 10,530 MJ (10,000 kBtu) would be the annual energy saved ($84 per year). This is about ¼ of the maximum possible savings but is all that can be achieved with a tile containing 20% PCM. This might be attractive enough for consumers if the tile is competitively priced.

While certain representative embodiments and details have been shown for the purpose of illustrating the invention, those skilled in the art will readily appreciate that various modifications, whether specifically or expressly identified herein, may be made to any of the representative embodiments without departing from the novel teachings or scope of this technical disclosure. Accordingly, all such modifications are contemplated and intended to be included within the scope of the claims. Although the commonly employed preamble phrase “comprising the steps of” may be used herein in a method claim, applicants do not intend to invoke 35 U.S.C. §112 ¶6. Furthermore, in any claim that is filed herewith or hereafter, any means-plus-function clauses used, or later found to be present, are intended to cover at least all structure(s) described herein as performing the recited function and not only structural equivalents but also equivalent structures.

What is claimed is:

1. An agglomerate tile structure fabricated of intermixed materials, comprising:
(a) at least 10% by mass of a binder material;
(b) at least 12% by mass of a phase change material (PCM) component; and
(c) at least 30% by mass of a granular base medium comprising at least one granular-sized stone.

2. The agglomerate tile structure of claim 1 wherein:
(a) said phase change material (PCM) component comprises a phase change material selected from the group consisting of a microencapsulated paraffin wax and a solid-state PCM; and
(b) said granular-sized stone is selected from the group of stone types consisting of quartz, granite, limestone, marble, glass, ceramic, and semiprecious stones.

3. The agglomerate tile structure of claim 2, for use as a flooring, and wherein:
(a) said phase change material (PCM) component comprises said micro-encapsulated paraffin wax;
(b) said binder material comprises a binder selected from the group consisting of polyester and epoxies; and
(c) said granular-sized stone is further selected from the group consisting of powdered quartz, crushed quartz, chips of quartz, and fragments of quartz.

4. The agglomerate tile structure of claim 1 wherein:
(a) said phase change material (PCM) component comprises a micro-encapsulated paraffin;
(b) said binder material comprises a polyester; and
(c) said granular-sized stone is selected from the group consisting of powdered, crushed, chips, and fragments of stone.

5. The agglomerate tile structure of claim 4, for use as a flooring, and wherein:
(a) said microencapsulated paraffin comprises octadecane microencapsulated within a thermoset plastic; and
(b) said granular base medium further comprises a second granular-sized stone of a granular size different from said first granular-sized stone, said second granular-sized stone selected from the group consisting of powdered quartz, crushed quartz, chips of quartz, and fragments of quartz.

6. The agglomerate tile structure of claim 1 wherein:
(a) said binder material is at least 12% by mass of the intermixed materials;
(b) said phase change material (PCM) component is at least 15% by mass of the intermixed materials; and
(c) said granular base medium further comprises a second granular-sized stone, said first granular-sized stone comprises chips of quartz and said second granular-sized stone comprises powdered quartz.

7. The agglomerate tile structure of claim 1 wherein:
(a) said binder material is at least 20% by mass of the intermixed materials;
(b) said phase change material (PCM) component is at least 20% by mass of the intermixed materials; and
(c) said granular base medium further comprises a second granular-sized stone.

8. An agglomerate tile structure fabricated of at least an outer layer bonded to a second layer, comprising:
(a) the second layer comprising at least 20% by mass of a binder material, at least 20% by mass of a phase change material (PCM) component, and generally absent of a granular base medium; and
(b) the outer layer comprising at least 10% by mass of said binder material and at least 40% by mass of said granular base medium comprising at least one granular-sized stone, and generally absent of said phase change material (PCM) component.

9. The agglomerate tile structure of claim 8 wherein:
(a) said phase change material (PCM) component comprises a phase change material selected from the group consisting of a microencapsulated paraffin wax and a solid-state PCM; and
(b) said granular-sized stone is selected from the group of stone types consisting of quartz, granite, limestone, marble, glass, ceramic, and semiprecious stones.

10. The agglomerate tile structure of claim 9, for use as a flooring, and wherein:
(a) said phase change material (PCM) component comprises said micro-encapsulated paraffin wax;
(b) said binder material comprises a binder selected from the group consisting of polyester and epoxies; and
(c) said granular-sized stone is selected from the group consisting of powdered quartz, crushed quartz, chips of quartz, and fragments of quartz.

11. The agglomerate tile structure of claim 8, for use as a flooring, and wherein:
(a) said phase change material (PCM) component comprises octadecane microencapsulated within a thermoset plastic; and
(b) said granular base medium further comprises a second granular-sized stone of a granular size different from said first granular-sized stone, said first and second granular-sized stone are each selected from the group of stone types consisting of quartz, granite, limestone, marble, glass, ceramic, and semiprecious stones.

12. A tile structure for use in a barrier between a circulation plenum within of a living space, comprising:
(a) a base support member having oppositely facing outer surfaces, one of said surfaces directed inwardly toward the circulation plenum;
(b) distributed about and extending from said inwardly directed surface are a plurality of fin protrusions; and
(c) said fin protrusions comprising at least 20% by mass of a binder material and at least 20% by mass of a phase change material (PCM) component.

13. The tile structure of claim 12 wherein:
(a) the barrier is a ceiling of the living space, the circulation plenum is above the ceiling and the living space is beneath the ceiling; and
(b) said phase change material (PCM) component comprises a phase change material selected from the group consisting of a microencapsulated paraffin wax and a solid-state PCM.

14. The tile structure of claim 12 wherein:
(a) the barrier is a vertical wall of the living space, the circulation plenum is defined on either side by the vertical wall and a second barrier wall, the living space is on the opposite side of the vertical wall; and
(b) said phase change material (PCM) component comprises a phase change material selected from the group consisting of a microencapsulated paraffin wax and a solid-state PCM.

15. The tile structure of claim 12 wherein:
(a) said fin protrusions are integrally molded with said inwardly directed surface and said base support member; and
(b) said fin protrusions have a shape selected from the group consisting of pin fin shaped, conical/cylindrical, tube-fin shaped, straight/rectangular, square pin shaped, circular/curvilinear, and an irregular shape.

16. The tile structure of claim 12 wherein:
(a) said fin protrusions are molded from an intermixture of said binder material and said phase change material (PCM) component, and permanently adhered to said inwardly directed surface of said base support member; and
(b) said phase change material (PCM) component comprises a phase change material selected from the group consisting of a microencapsulated paraffin wax and a solid-state PCM.
